(19) United States
(12) Patent Application Publication
(10) Pub. No.: US 2016/0176684 A1
(43) Pub. Date: Jun. 23, 2016

(54) LUFFING CROSS MEMBER

(71) Applicant: LIEBHERR-WERK BIBERACH GMBH, Biberach an der Riss (DE)

(72) Inventors: Alfred HESS, Gutenzell/Huerbel (DE); Florian FRANZESKO, Aichstetten (DE)

(21) Appl. No.: 14/909,450

(22) PCT Filed: Jul. 30, 2014
(86) PCT No.: PCT/EP2014/002094

§ 371 Date: Feb. 1, 2016

(30) Foreign Application Priority Data
Jul. 30, 2013 (DE) 10 2013 012 658.4

(51) Int. Cl. B66C 1/22; B66C 13/08; B66C 1/10

(52) U.S. Cl. CPC B66C 1/22; B66C 1/10; B66C 13/08

(57) ABSTRACT

The present invention relates to a luffing cross member for transloading a load by means of a hoist, with a cross member centerpiece, a crane attachment point for attaching the luffing cross member to the hoist, at least two load attaching points for attaching the load to the luffing cross member, and a drive unit by means of which at least one load attachment point, is movable relatively to the cross member centerpiece.

The present invention relates to a luffing cross member for transloading loads.

Cross members for transloading loads are known from the prior art and serve, for example, to attach particularly bulky loads to hoists, specifically to hoist hooks. These can be, for example, particularly large loads, i.e. spatially large-sized loads, where a single hoist hook provides little stability as a single attachment point. The usual cross members correspond in their structure to a cross member, which is hinged to a hoist hook and whose outer areas are used as attachment points for the load to be lifted.

During the load lifting process, there may arise the task that an originally horizontally positioned load must be brought into a vertical position or vice versa. This task can arise in different hoist work situations, e.g. when the hoist is used as an assembly aid on construction sites, where for instance the tower piece, boom, precast concrete parts, components, transmission platforms, or the counter-jib of the hoist must be brought from a horizontal to a ready-to-be-mounted or vertical position.

From the prior art, it is known to solve this problem by using a so-called “fly jib” device, which expands an ordinary crane boom by an additional, second jib and thus provides two independently controllable crane attachment points. By means of these two attachment points provided on the crane, it is possible to bring a load attached to it from an original horizontal to a vertical orientation and vice versa.

A disadvantage of this device is, however, that in this case a correspondingly configured crane must be provided and the problem of load orientation cannot be solved with already existing conventional cranes. Furthermore, with this configuration, the rotation of the load about the vertical axis is not possible.

Also, the tilting of suspended loads by erection or partial erection of the load on the ground and the subsequent putting down of the load by simultaneously rotating and lowering the crane are known methods for rotating loads suspended from cranes.

Likewise, it is known to install balance pieces, such as a shackle so as to achieve a desired horizontal position or alignment of a load. A disadvantage of this method is that the loads can be damaged mostly at the tipping edges and that the procedures themselves are cumbersome because they include special auxiliary steps and devices.

The technical task of the present invention is therefore to provide a device that enables a hoist with at least one attachment point to carry out the aforementioned task of the load rotation.

This technical problem is solved with a luffing cross member with the features of claim 1, wherein a luffing cross member is provided for attaching a load by means of a hoist, with a cross member centerpiece, a hoist attachment point for attaching the luffing cross member to the hoist, at least two load attaching points for attaching the load to the luffing cross member and a drive unit, by means of which at least one load attaching point is movable relatively to the cross member centerpiece.

The movable arrangement of the at least one load attachment point, which is ensured by means of the drive unit provided on the luffing cross member, makes it possible to vary the distance between the moving load attaching point and the load and to adjust its orientation for example to align an originally horizontally suspended load vertically, or vice versa.

Preferred embodiments of the inventive luffing cross member result from the sub-claims following the main claim.

Accordingly, it is conceivable in a preferred embodiment that the at least one attachment point movable relatively to the cross member centerpiece is connected with the cross member centerpiece via a winch. The winch advantageously enables also a flexible deflection of the load rope running within the winch. This is necessary particularly because during the rotation of the load from a horizontal to a vertical direction, the cross member geometry is changed accordingly and thus a variable load cable conduit is needed.

In a further preferred embodiment, it is conceivable that the winch is designed as a simple winch, a winch with double drum, traction hoist, capstan winch, pulley, wire rope hoist, chain hoist, lever hoist, hand winch, fluid hoist, or compressed air winch. Depending on the application of the luffing cross member, it is advantageously possible, in addition to the flexible or movable load cable guide, to ensure an appropriate power transmission within the load rope.

In a further preferred embodiment, it is conceivable that the drive unit is provided on the cross member central piece and is designed as an electric motor, hydraulic drive, internal combustion engine and/or as a hybrid drive. The provision of the drive unit at the cross member centerpiece advantageously ensures that the luffing cross member as a functional component in itself can be operated independently of other peripheral devices. The driving modes most suitable for the particular place of use can also be advantageously selected.

In a further preferred embodiment, it is conceivable that an energy storage device is connected to the drive unit, which supplies the drive unit with energy, whereby the energy storage device stores energy during the lowering of the load. This is particularly advantageous if the energy storage is, for example, a battery or an accumulator. In this way it is possible to convert and store the potential energy of the load released when lowering a load into chemical energy or pressure energy. The energy thus stored can then be used again for lifting the load, if needed.

In a further preferred embodiment, it is conceivable that the load attachment points are designed as rolls or as a shackle/hook, whereby the role component is mandatory only with two or more attachment points. In particular, the configuration of the load attachment points as shackles permits a quick and easy attachment or detachment of the load.

In a further preferred embodiment, it is conceivable that the cross member centerpiece is formed as a collapsible triangular construction of two tie rods and a strut, wherein at least one of the tie rods is designed as a hinged member. Such a triangular arrangement of cross member centerpiece, in which at least one of the tie rods is carried out in an articulated design, allows advantageously to disassemble the cross member centerpiece, if necessary, and to downsize it in its dimensions, for example for transport.

In a particularly preferred embodiment, it is conceivable that at least one tension strut formed as an articulated element is collapsible in the ratio 1:2.

In a further preferred embodiment, it is conceivable that a control is provided for the drive unit, wherein the controller is integrated into a crane control or is provided with a separate remote radio or cable control, independently from this crane control. Advantageously, the crane operator can freely select how to put the luffing cross member into operation. Thus, the controller can be flexibly customized.

The invention further relates to a method for transloading a load by means of a luffing cross member according to any one of claims 1 to 9, comprising the steps of

horizontal lifting a horizontally positioned load and
moving at least one load attachment point relatively to the cross member centerpiece.

Further details and advantages of the invention are explained based on embodiments shown in the figures. The figures show:

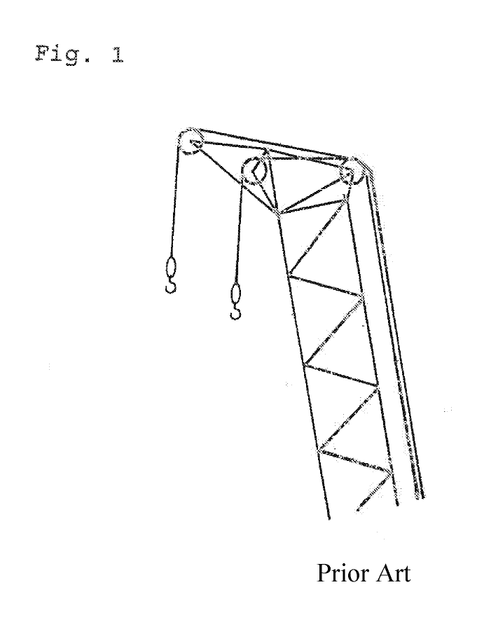

FIG. 1 shows a “fly jib” device known from the prior art,

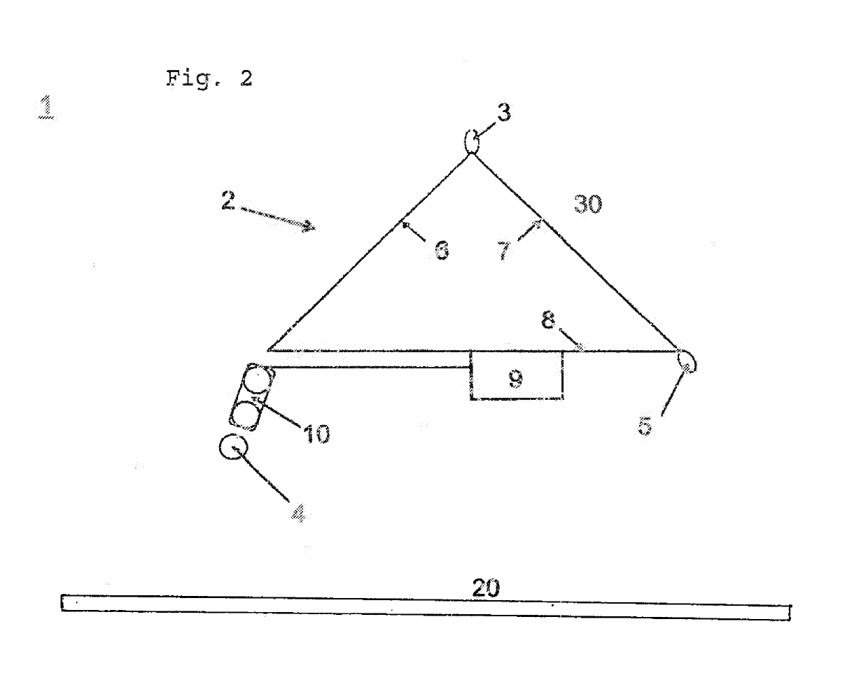

FIG. 2 shows a luffing cross member with horizontal load orientation,

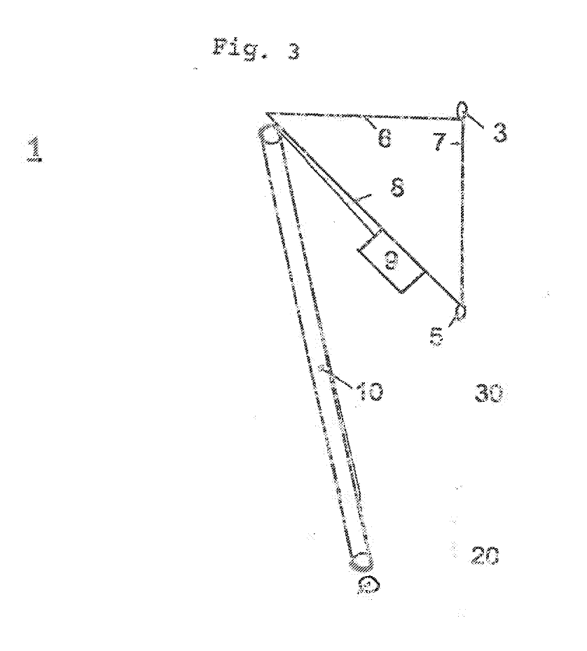

FIG. 3 shows a luffing cross member with vertical load orientation, and

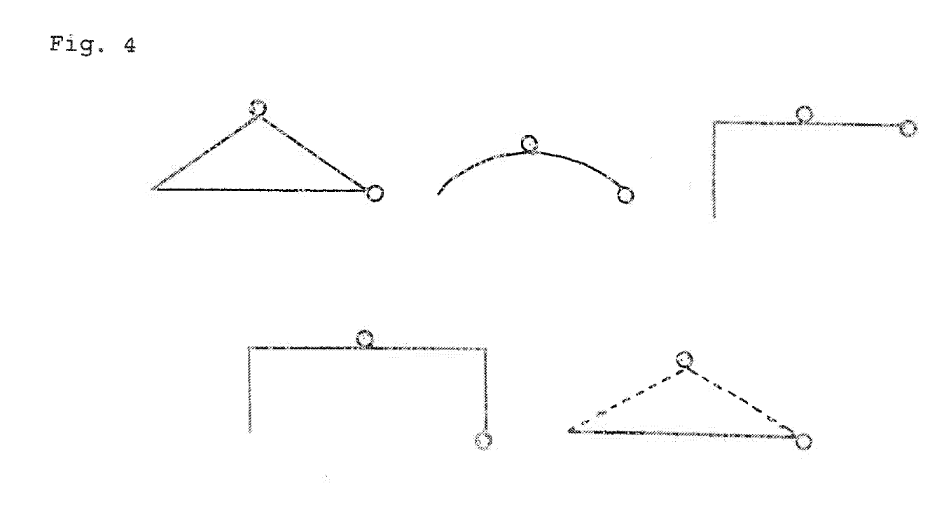

FIG. 4 shows alternative embodiments of the cross member centerpiece.

FIG. 1 shows a crane tip with a so-called “fly jib”. This is a well-known device in the prior art, with which loads lifted by a crane can be moved between a horizontal and a vertical direction. It is also known to change the position of the load by using a second crane, by means of towing equipment such as ratchet hoist, or chain hoists, or by hand.

FIG. 2 shows a luffing cross member 1 for transloading a load 20, in which the load 20 is in a horizontal alignment. The situation described in FIG. 2 corresponds, for example, to that when lifting an elongate load 20 from a horizontal storage position, which is the case, for example, when supporting a crane element on a transport vehicle. In the illustrated embodiment, the cross member centerpiece 2 is designed as a triangular structure. The top of the cross member centerpiece 2 is a crane attachment point 3, through which the cross member centerpiece 2 or the luffing cross member 1 can be connected to the attachment points of a hoist. Here, for example, the load hook of a hoist can be connected with the luffing cross member 1.

At the bottom of the luffing cross member 1 are located two load attaching points 4, 5 to attach the load 20 to the luffing cross member 1. Also, at the bottom of the luffing cross member 1 a drive unit 9 is provided by means of which at least one of the load attaching points 4, 5 can be moved relatively to the cross member centerpiece 2 by a pulley 10. In the shown embodiment, the pulley 10 is extended by means of the drive unit 9, wherein the drive unit 9 feeds a load cable to the pulley 10.

This extension of the pulley 10 results in a lowering of the left load attachment point 4 so that, as shown in FIG. 3, the load 20 is moved from a horizontal direction into a vertical alignment.

Since in the usual lifting operations the winch discharges mainly loads 20, i.e. components are turned mainly from a horizontal to a vertical position, during ordinary hoisting operation potential energy of the component is released and can be converted and stored by means of the drive unit 9.

If an electric motor is used as the drive unit 9, it can be used when lowering the load 20 as a generator, to produce electrical energy, which can be stored in a power storage not shown, such as an accumulator.

The power supply of the drive unit 9 can either be ensured by a supply line from the ground or from the hoist, or there can also be provided an energy source which is provided directly at the luffing cross member 1.

The same applies to the use of a hydraulic motor, which can be used during the lowering of the load 20 as the pump so as to store energy in an accumulator, also not shown.

The luffing cross member 1 shown in FIG. 2 has a cross member centerpiece 2, which is designed as a collapsible triangular device. Here, two tie rods 6, 7 are connected to a strut 8, so that a triangular structure is formed. In order to ensure a better transportability of the luffing cross member 1, it can be provided that at least one of the tie rods 6, 7 is designed as an articulated component. It is conceivable that the articulated tie rod 6, 7 is collapsible in the ratio 1:2.

FIG. 3 shows the luffing cross member 1 in a state in which the load 20 is now present vertically tilted. In order to move from the horizontal state shown in FIG. 2, into the vertical state shown now in FIG. 3, the drive unit 9 releases a load cable until the pulley 10 has been extended to the corresponding required length. The load 20 thereby rotates by its own weight from the horizontal to the vertical position. The luffing cross member 1 itself likewise changes its position in space, as shown in FIG. 3. The force path 30 shown in dashed lines extends now almost vertically and not, as shown in FIG. 2, in an angle.

Using the device shown here, components can be lifted and suspended aligned longitudinally, erected or placed down. The reverse rotation of the components can also be performed. The placing is carried out continuously (+/−90°) so that the device can be used as an assembly/disassembly aid. Conceivable are e.g. uses for erecting/placing components, adjusting any misalignment and aligning connection points.

When moving prefabricated concrete parts, for example, they are delivered on a truck lying and then need to be erected while floating.

Another field of application of the present invention relates to the crane assembly. Crane tower sections can be erected which, like the aforementioned prefabricated concrete parts, must also be delivered lying and erected on a truck. The gear platform, counter-jib, boom and other components of the crane can be aligned horizontally or vertically with the present invention in order to be assembled or disassembled. This saves the operators the “grope” to a horizontal position of the elements by repeatedly fastening them by using shackles, compensation hangers and the like.

The present invention can be used in all kinds of lifting equipment. Also, several devices can be combined.

The device can also be used as an assembly aid in production processes or during the erection of vehicles involved in accidents. Generally, the device relates to processes, in which objects must be raised and subsequently turned in a controlled manner.

While the components are aligned, erected or placed in the longitudinal direction, they can be simultaneously rotated around the load hook. It is also conceivable to horizontally align components by a combination of several inventive devices or by modified devices.

FIG. 4 shows alternative embodiments of the cross member centerpiece 2 of the luffing cross member 1. In this case, the same function as that of the triangular constructions shown in FIGS. 2 and 3 with tie rods 6, 7 and the strut 8 with a curved bending beam or with a frame can be achieved, or the tie rods 6, 7 can also be replaced by a hanger.

1. A luffing cross member for transloading a load by means of a hoist, comprising a cross member centerpiece, a crane attachment point for attaching the luffing cross member to the hoist, at least two load attachment points for attaching the load to the luffing cross member and a drive unit, by means of which at least one load attachment point can is movable relative to the cross member centerpiece.

2. The luffing cross member according to claim 1, wherein the at least one load attachment point movable relative to the cross member centerpiece is connected to the cross member centerpiece via a winch.

3. The luffing cross member according to claim 2, wherein the winch is one or more of a double drum, traction hoist, capstan winch, pulley, wire rope hoist, chain hoist, lever hoist, hand winch, fluid hoist, or compressed air winch, and which is executed with a pulley or a direct cable.

4. The luffing cross member according to enc of claim 1, wherein the drive unit is provided on the cross member centerpiece and is one or more of an electric motor, hydraulic drive, internal combustion engine and/or as a hybrid drive.

5. The luffing cross member according to claim 1, wherein an energy storage device is connected to the drive unit, which supplies the drive unit with power, wherein the energy storage stores energy when the load is lowered.

6. The luffing cross member according to claim 1, wherein the load attaching points are rolls or a shackle.

7. The luffing cross member according to claim 1, wherein the cross member centerpiece is a collapsible triangular construction of two tie rods and a strut, wherein at least one of the tie rods is a hinged member.

8. The luffing cross member according to claim 7, wherein the at least one tie rod is is collapsible in a ratio of 1:2.

9. The luffing cross member according to claim 1, further comprising a controller for the drive unit, wherein the controller is integrated into a crane control or is provided independently of the crane control with a separate radio or cable remote control.

10. A method for transloading a load by means of a luffing cross member comprising a cross member centerpiece, a crane attachment point for attaching the luffing cross member to the hoist, at least two load attachment points for attaching the load to the luffing cross member and a drive unit, comprising the steps of:
a) lifting a load; and
b) moving at least one load attachment point relative to the cross member centerpiece, wherein at least one load attachment point is movable relative to the cross member centerpiece by the drive unit.
